(19) United States
(12) Patent Application Publication
(10) Pub. No.: US 2006/0019730 A1
(43) Pub. Date: Jan. 26, 2006

(54) Antenna for mobile communication terminal

(75) Inventors: Hong-Teuk Kim, Gyeonggi-do (KR); Young-Joon Ko, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/156,486

(22) Filed: Jun. 21, 2005

(30) Foreign Application Priority Data
Jun. 23, 2004 (KR) 47246/2004

(51) Int. Cl. H04M 1/00

(52) U.S. Cl. 455/575.7

(57) ABSTRACT

An antenna of a mobile communication terminal comprises: a first antenna portion having a plurality of strip portions curved with a certain interval, and having a feed point for an electric connection at one end thereof; a second antenna portion having a plurality of strip portions curved with a certain interval, having an earth point for contacting a ground surface at one end thereof, and spaced from the first antenna portion with a certain interval; and a connecting unit for connecting the first antenna portion and the second antenna portion. The antenna for a mobile communication terminal implements a dual band, enhances a bandwidth of a low frequency band, and is minimized.

### BACKGROUND OF THE INVENTION

1. Field of the Invention

The present invention relates to an antenna for a mobile communication terminal, and more particularly, to an antenna for a mobile communication terminal capable of implementing a dual band, enhancing a bandwidth in a low frequency band, and being minimized.

2. Description of the Conventional Art

A mobile communication terminal has been continuously developed in pursuit of a minimization, a multifunction, a light characteristic, and a low consumption power. An antenna, one of necessary factors to the mobile communication terminal manages a starting and an ending of a signal input/output and determines a calling quality. The antenna has to be differently designed according to a shape and a material of the mobile communication terminal.

FIG. 1 is a view showing a structure of a mobile communication terminal in accordance with the conventional art.

As shown, the conventional mobile communication terminal comprises a body 110 having a main PCB (not shown) for inputting information and controlling communication therein, and a folder 120 having an LCD panel 121 for outputting information as an image and coupled to the body 110.

A camera 130 for photographing an object is installed at an upper end of a front surface of the body 110, and an antenna 140 for transmitting and receiving a wireless communication signal is installed at one side of an upper end of the body 110.

As the antenna 140 used for a wireless communication of the mobile communication terminal, a mono-pole antenna or a helical antenna, one of external antennas is mainly used.

However, a mobile communication terminal to which the external antenna is applied has an inferior appearance by the antenna 140 protruded outward in order to transmit and receive a wireless communication signal, and has a difficulty in being carried or stored. Also, the mobile communication terminal can be easily damaged by an external impact.

Also, as the antenna 140 is fixed to the mobile communication terminal as a protruded state, the size of the mobile communication terminal is increased and various installations are limited.

Accordingly, a mobile communication terminal having an internal antenna (not shown) has been proposed in order to solve the problems of the external antenna 140.

That is, an internal antenna such as a chip antenna or a planar inverted-F antenna is applied to the mobile communication terminal thereby to solve the problems due to the external antenna.

However, in case of the planar inverted-F antenna, a bandwidth is narrow and thus an emitting efficiency of the antenna is lowered according to a reflection loss of an input terminal, thereby decreasing an antenna gain. Also, since the planar inverted-F antenna has a resonance in ¼ of wavelength, the size of the antenna is increased and the size of the terminal is increased due to a limitation of an inner space of the mobile communication terminal. Accordingly, it is difficult to minimize the mobile communication terminal and make the mobile communication terminal light.

Also, in case of the ceramic chip antenna, a high dielectric material is used thereby to lower an emitting efficiency and to decrease an antenna gain.

### SUMMARY OF THE INVENTION

Therefore, an object of the present invention is to provide an antenna for a mobile communication terminal capable of implementing a dual band, enhancing a bandwidth of a low frequency band, and being minimized.

To achieve these and other advantages and in accordance with the purpose of the present invention, as embodied and broadly described herein, there is provided an antenna of a mobile communication terminal comprising: a first antenna portion having a plurality of strip portions curved with a certain interval, and having a feed point for an electric connection at one end thereof; a second antenna portion having a plurality of strip portions curved with a certain interval, having an earth point for contacting a ground surface at one end thereof, and spaced from the first antenna portion with a certain interval; and a connecting unit for connecting the first antenna portion and the second antenna portion.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a view showing a structure of a mobile communication terminal in accordance with the conventional art;

FIG. 2 is a view showing a structure of an antenna according to the present invention;

FIGS. 3A and 3B are sectional views taken along line III-III in FIG. 2;

FIGS. 4A to 4C are views showing a modification example of each antenna portion according to the present invention;

FIGS. 5 and 6 are views showing another embodiment of the antenna according to the present invention;

FIG. 7 is a sectional view taken along line VII-VII in FIG. 6;

FIG. 8 is a view schematically showing that the antenna of the present invention is applied to a mobile communication terminal;

FIG. 9 is a graph showing a reflection loss in a dual band of the antenna according to the present invention; and

FIG. 10 is a graph showing a reflection loss in a triple band of the antenna according to the present invention.

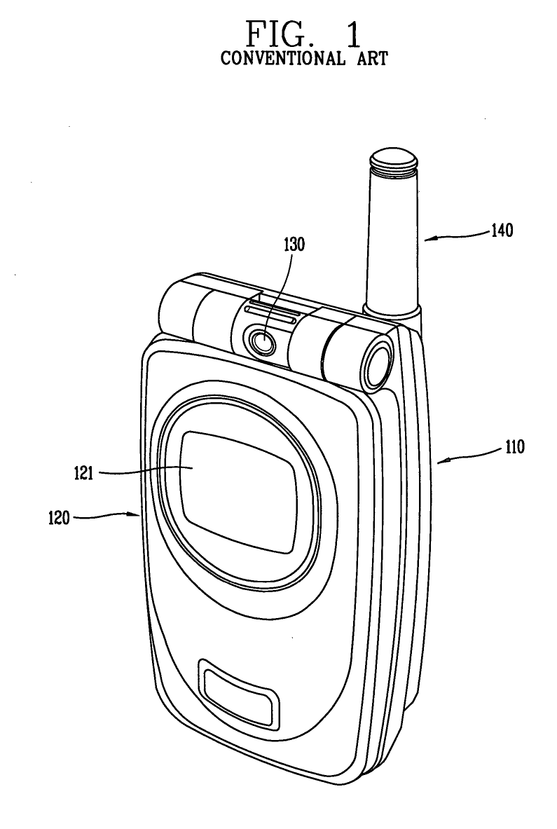

### DETAILED DESCRIPTION OF THE PREFERRED EMBODIMENTS

Reference will now be made in detail to the preferred embodiments of the present invention, examples of which are illustrated in the accompanying drawings.

Hereinafter, an antenna for a mobile communication terminal according to the present invention will be explained with reference to attached drawings.

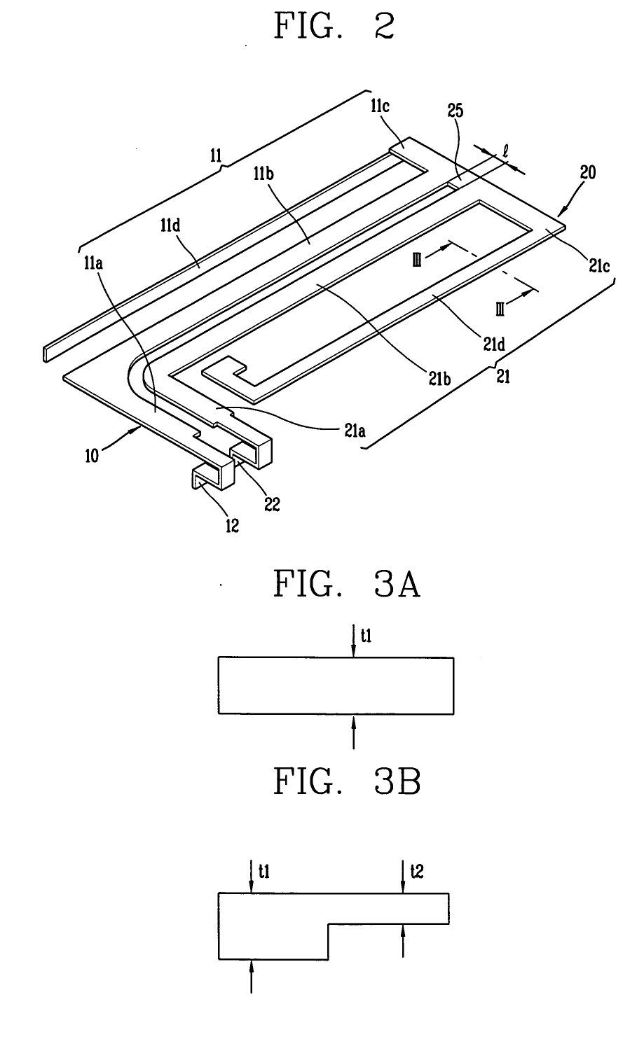

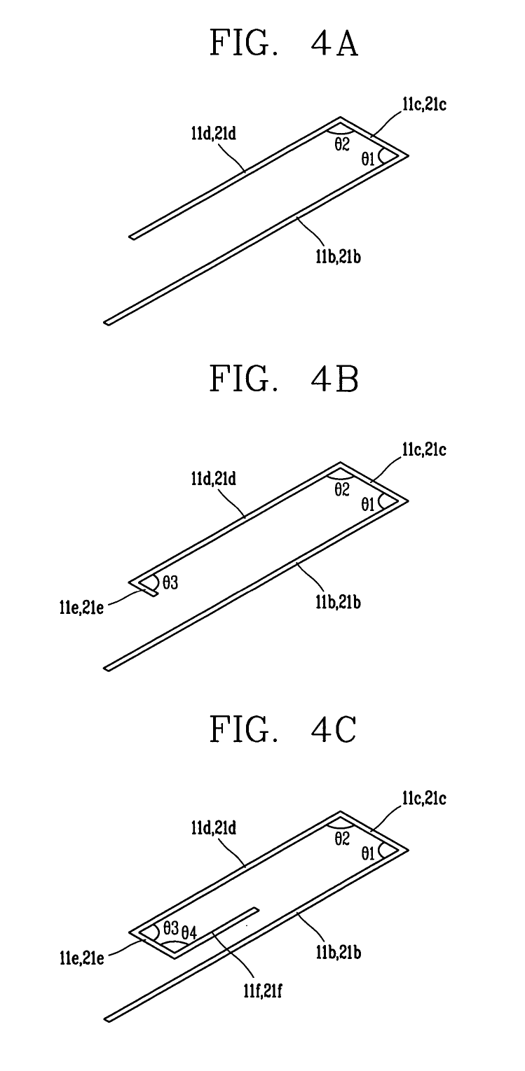

FIG. 2 is a view showing a structure of an antenna according to the present invention, FIGS. 3A and 3B are sectional views taken along line III-III in FIG. 2, and FIGS. 4A to 4C are views showing a modification example of each antenna portion according to the present invention.

As shown in FIG. 2, an antenna of a mobile communication terminal according to the present invention comprises a first antenna portion 10 having a plurality of strip portions 11 curved with a certain interval and having a feed point 12 for an electric connection at one end thereof; a second antenna portion 20 having a plurality of strip portions 21 curved with a certain interval, having an earth point 22 for contacting a ground surface at one end thereof, and spaced from the first antenna portion with a certain interval; and a connecting unit 25 for connecting the first antenna portion 10 and the second antenna portion 20.

As the antenna of the present invention, two folded mono-pole antennas (first antenna portion and second antenna portion) are used.

The first antenna portion 10 comprises a first strip portion 11a having a feed point 12 for an electric connection at one end thereof, a second strip portion 11b curved from the end of the first strip portion 11a, a third strip portion 11c curved from the end of the second strip portion 11b, and a fourth strip portion 11d curved from the end of the third strip portion 11c. The respective strip portions 11 are consecutively connected to each other thereby to form a strip pattern.

The second antenna portion 20 comprises a first strip portion 21a having an earth point 22 for contacting a ground surface at one end thereof, a second strip portion 21b curved from the end of the first strip portion 21a, a third strip portion 21c curved from the end of the second strip portion 21b, and a fourth strip portion 21d curved from the end of the third strip portion 21c. The respective strip portions 21 are consecutively connected to each other thereby to form a strip pattern.

A line for supplying electric energy to an antenna is called as a feed line, and a contact point for contacting the feed line is called as a feed point. Also, a contact point for contacting a ground surface is called as an earth point. The feed point may be formed at the second antenna portion 10 and the earth point may be formed at the first antenna portion 20.

Each strip portion 11 and 21 constituting the first antenna portion 10 and the second antenna portion 20 is inwardly curved. Preferably, each strip portion 11 of the first antenna portion 10 and each strip portion 21 of the second antenna portion 20 are inwardly curved in an opposite direction to each other.

That is, the second strip portion 11b of the first antenna portion 10 is curved from the end of the first strip portion 11a so as to have a certain length and a certain width in a right direction, and the third strip portion 11c of the first antenna portion 10 is curved from the end of the second strip portion 11b so as to have a certain length and a certain width in a back direction. Also, the fourth strip portion 11d of the first antenna portion 10 is curved from the end of the third strip portion 11c so as to have a certain length and a certain width in a left direction.

The second strip portion 21b of the second antenna portion 20 is curved from the end of the first strip portion 21a so as to have a certain length and a certain width in a right direction, and the third strip portion 21c of the second antenna portion 20 is curved from the end of the second strip portion 21b so as to have a certain length and a certain width in a forward direction. Also, the fourth strip portion 21d of the second antenna portion 20 is curved from the end of the third strip portion 21c so as to have a certain length and a certain width in a left direction.

Each strip portion 11 and 21 constituting the first antenna portion 10 and the second antenna portion 20 is respectively composed of first to fourth strip portions (11a to 11d, 21a to 21d). However, as shown in FIGS. 4A to 4C, a plurality of strip portions 11e and 11f, 21e and 21f may be additionally curved from the end of the fourth strip portions 11d and 21d of the first antenna portion 10 and the second antenna portion 20 thereby to form a consecutive strip pattern.

As each strip portion 11 and 21 is inwardly curved, different internal angles (Θ1, Θ2, Θ3 . . . Θn) are formed. Preferably, the internal angle of each strip portion 11 and 21 is formed to have a range of 45° to 135°.

When the internal angle of each strip portion 11 and 21 is less than 45°, an interval between each strip portion is narrow thereby to lower an antenna characteristic. On the contrary, when the internal angle of each strip portion 11 and 21 is more than 135°, an entire size of the antenna is increased. Accordingly, the internal angle of each strip portion 11 and 21 is formed to have a range of 45° to 135°. More preferably, the internal angle of each strip portion 11 and 21 is formed to be 90°.

Each strip portion 11 and 21 for forming the first antenna portion 10 and the second antenna portion 20 is formed on the same plane.

At least one of the strip portion 11 and 21 of the first antenna portion 10 and the second antenna portion 20 is curved along a thickness direction in order to prevent a width increment at the time of a plane projection of the first antenna portion 10 and the second antenna portion 20.

That is, as shown in FIG. 2, the fourth strip portion 11d of the first antenna portion 10 is curved from the end of the third strip portion in the left direction, and is curved along the thickness direction (preferably, curved as 90°) thereby to decrease the size of the antenna.

The third strip portion 21c and the fourth strip portion 21d of the second antenna portion 20 can be selectively curved in the thickness direction or together with the fourth strip portion 11d of the first antenna portion 10.

The thickness of the first antenna portion 10 and the second antenna portion 20 can be variously implemented along the width direction thereof. That is, as shown in FIG. 3A, the first antenna portion 10 and the second antenna portion 20 may have a constant thickness t1 that is not varied in the width direction. Also, as shown in FIG. 3B, the first antenna portion 10 and the second antenna portion 20 may have thickness t1 and t2 varied according to steps. Also, although not shown, the first antenna portion 10 and the second antenna portion 20 may have a thickness consecutively varied in the width direction. Also, the first antenna portion 10 and the second antenna portion 20 may have thickness varied according to each strip portion thereof.

In the first antenna portion 10 and the second antenna portion 20, each strip portion 11 and 21 is inwardly curved to form a strip pattern. Also, the first antenna portion 10 and the second antenna portion 20 are spaced from each other with a certain interval and are connected to each other by the connecting unit 25. Accordingly, the antenna can be minimized, a resonance characteristic of the entire antenna can be enhanced, a wide bandwidth can be obtained, and a power loss generated from an input terminal is decreased thereby to minimize a lowering of a reception sensitivity.

Also, each width of the first antenna portion 10 and the second antenna portion 20 and an interval l therebetween are controlled thereby to control an impedance properly.

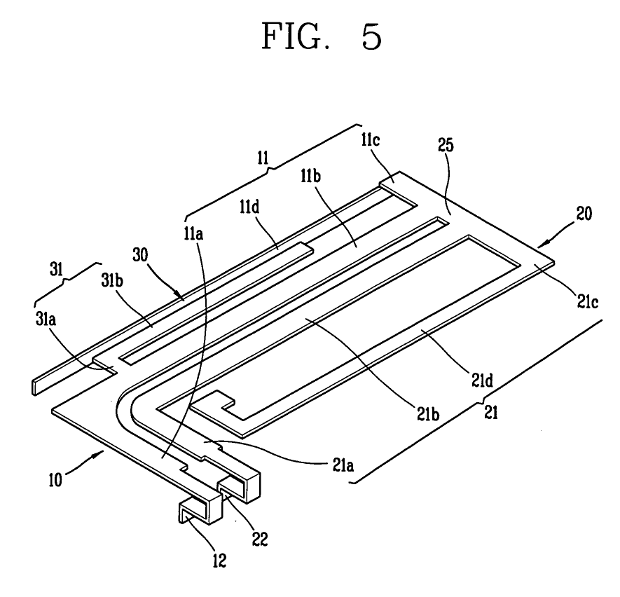

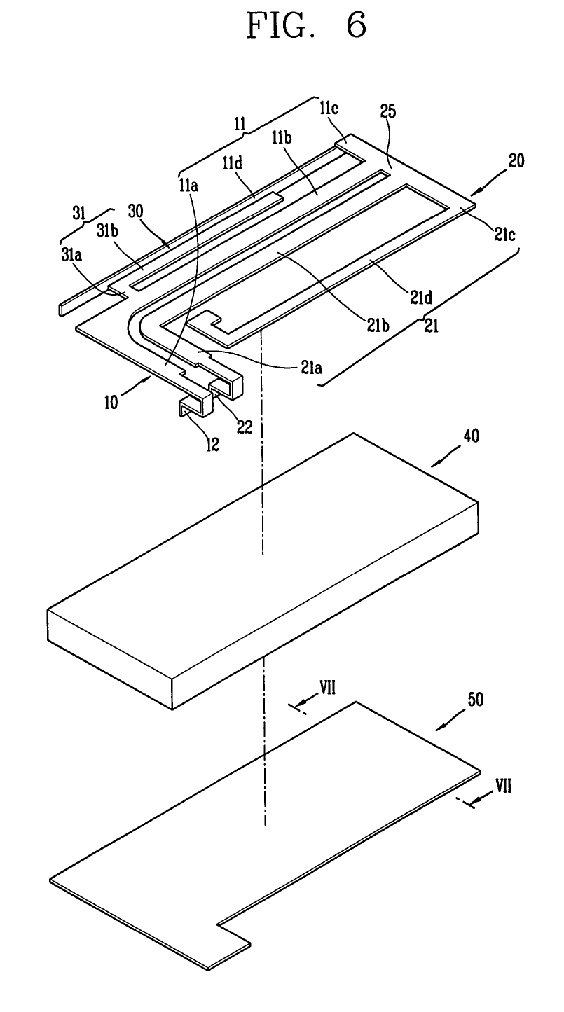

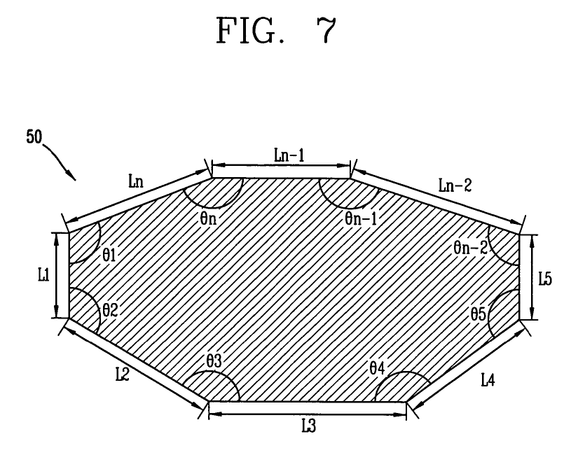

Hereinafter, another embodiment of the present invention will be explained with reference to the attached drawings. FIGS. 5 and 6 are views showing another embodiment of the antenna according to the present invention, and FIG. 7 is a sectional view taken along line VII-VII in FIG. 6.

The same reference numerals were given to the same parts as those of the aforementioned embodiment, and the minute explanation will be omitted.

As shown in FIG. 5, the antenna according to another embodiment of the present invention comprises a first antenna portion 10 having a plurality of strip portions 11 curved from each end with a certain angle thereby to be consecutively connected to form a strip pattern and having a feed point 12 for an electric connection at one end thereof; a second antenna portion 20 having a plurality of strip portions 21 curved from each end with a certain angle thereby to be consecutively connected to form a strip pattern and having an earth point 22 for contacting a ground surface at one end thereof, and spaced from the first antenna portion 10 with a certain interval; a connecting unit 25 for connecting the first antenna portion 10 and the second antenna portion 20; and an auxiliary antenna portion 30 integrally connected to at least one of the first antenna portion 10 and the second antenna portion 20 for implementing a dual band with the first antenna portion 10 and the second antenna portion 20.

The auxiliary antenna portion 30 comprises a first strip portion 31a connected to one of the first antenna portion and the second antenna portion, and a second strip portion 31b curved from the end of the first strip portion 31a. A plurality of strip portions curved from the end of the second strip portion 31b with a certain angle and consecutively connected to each other to form a strip pattern may be further formed.

Each strip portion 31 constituting the auxiliary antenna portion 30 is inwardly curved, and thereby different internal angles (Θ1, Θ2, Θ3 . . . Θn) are formed. Preferably, the internal angle of each strip portion 31 is formed to have a range of 45° to 135°.

Each strip portion 31 of the auxiliary antenna portion 30 is formed on the same plane as that of each strip portion of the first antenna portion 10 and the second antenna portion 20.

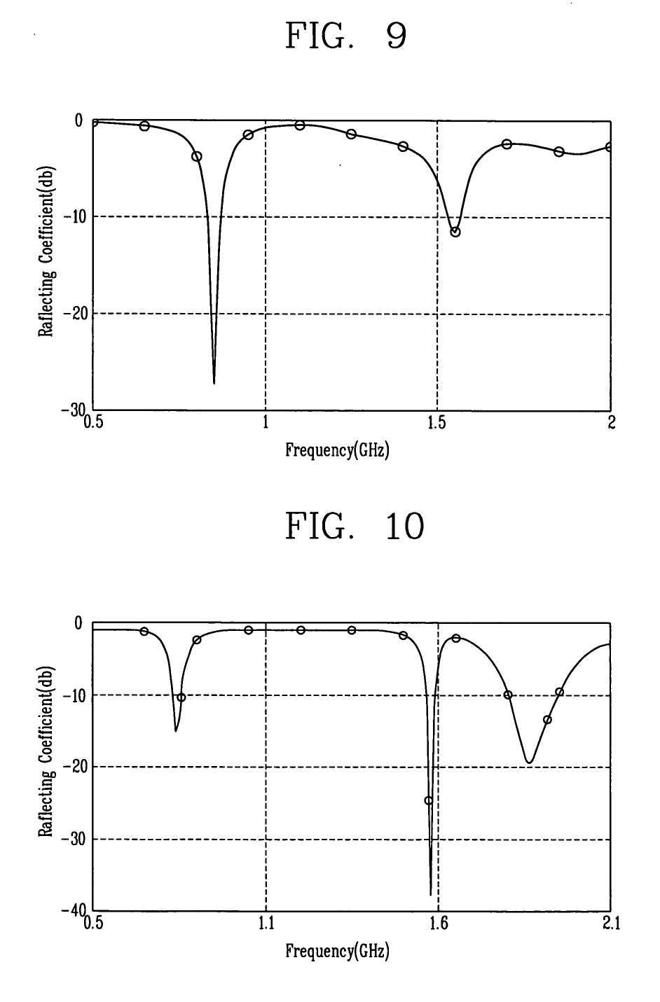

In the present invention, not only the first antenna portion 10 and the second antenna portion 20 but also the auxiliary antenna portion 30 for implementing a dual band is provided, thereby implementing a dual band such as a CDMA band/a GPS band and a CDMA band/a PCS band selectable in a frequency band. The details will be explained with reference to FIGS. 9 and 10.

As another embodiment of the present invention, the aforementioned antenna portions may be selectively provided with an antenna supporting unit 40 for supporting each antenna portion 10, 20, and 30 as shown in FIG. 6.

That is, the antenna supporting unit 40 has a shape corresponding to each antenna portion 10, 20, and 30 at the time of a plane projection and is formed of a dielectric material such as ceramic, resin, etc. with a certain thickness, thereby supporting each antenna portion 10, 20, and 30. Each antenna portion 10, 20, and 30 may be formed as an electrode having a certain thickness, and may use an air layer instead of the antenna supporting unit 40.

Each antenna portion 10, 20, and 30 constituting the antenna can be deposited on the antenna supporting unit 40 by a conductive material such as gold, silver, copper, etc.

A ground portion 50 to which the earth point 22 is electrically connected may be selectively provided at a lower portion of each antenna portion 10, 20, and 30 with the antenna supporting portion 40.

As shown in FIG. 6, the ground portion 50 is a limited ground having a plate shape corresponding to the first antenna portion 10 and the second antenna portion 20 at the time of a plane projection. As shown in FIG. 7, the ground portion 50 is formed as a polygonal shape that each edge (L1, L2, L3 . . . . Ln) has a length less than ¼ of a wavelength, and internal angles (Θ1, Θ2, Θ3 . . . Θn) are differently formed. Preferably, the internal angles are respectively formed to have a range of −90° to 90°.

It is also possible to form an air layer at a lower portion of each antenna portion 10, 20, and 30 instead of the ground portion 50.

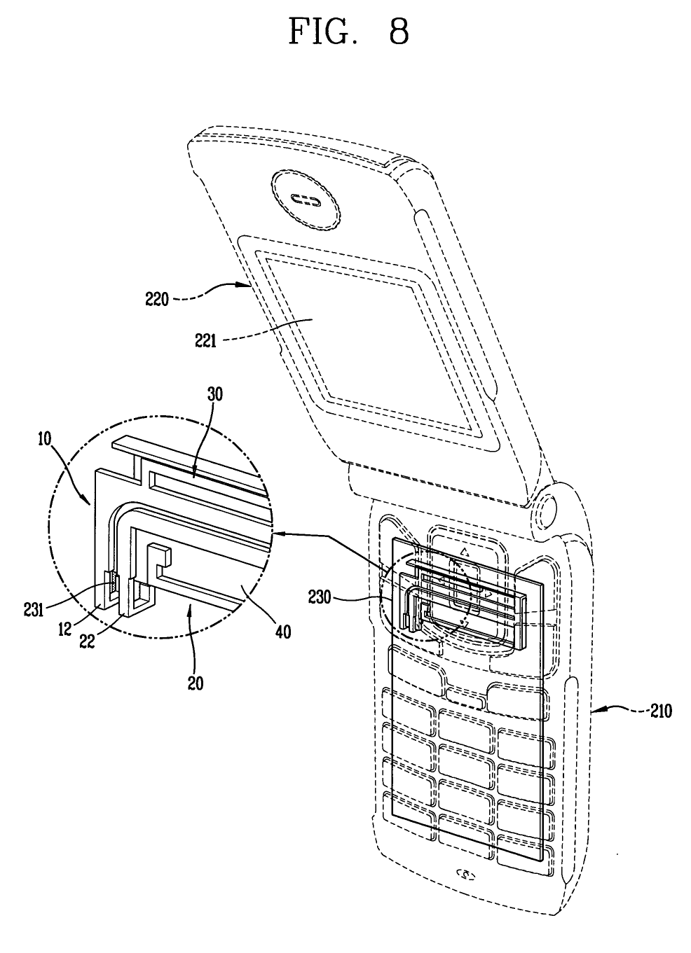

FIG. 8 is a view schematically showing that the antenna of the present invention is applied to a mobile communication terminal.

As shown, the mobile communication terminal having an antenna of the present invention comprises a body 210 having a main PCB 230 therein, a folder 220 having an LCD panel 221 for outputting information as an image and coupled to the body 210, and an antenna installed in the body.

The antenna comprises a first antenna portion 10, a second antenna portion 20, an auxiliary antenna portion 30, an antenna supporting unit 40 for supporting each antenna portion 10, 20, and 30, and a ground portion 50. Each antenna portion 10, 20, and 30 is formed of an electrode having a certain thickness by the antenna supporting unit 40.

A feeding pad 231 formed as a ground layer (not shown) is partially removed for connecting the feed point 12 of the first antenna portion 10 is provided at one side of an upper portion of the main PCB 230. The ground point 12 is connected to the main PCB 230 through the feeding pad 231, and the earth point 22 of the second antenna portion 20 is connected to the ground layer of the main PCB 230.

The ground potion 50 is arranged at a lower portion of each antenna portion 10, 20, and 30 and is electrically connected to the ground layer of the main PCB 230. The ground portion 50 and the antenna supporting unit 40 may be selectively removed.

The antenna according to the present invention can be mounted in the mobile communication terminal as an internal type or can be mounted outside the mobile communication terminal as an external type. Also, the antenna can be applied to any kind of mobile communication terminal such as a bar type, a flip type, a PDA type, etc.

FIG. 9 is a graph showing a reflection loss in a dual band of the antenna according to the present invention.

Referring to FIG. 9, the antenna according to the present invention can implement a dual band selectable between 800 MHz band and 1500 MHz band, and can increase a bandwidth more than approximately 10%.

The low frequency band (800 MHz) of the antenna according to the preset invention is implemented by the first antenna portion 10 and the second antenna portion 20, and the high frequency band (1500 MHz) is implemented by the auxiliary antenna portion 30.

FIG. 10 is a graph showing a reflection loss in a triple band of the antenna according to the present invention.

Referring to FIG. 10, the antenna according to the present invention can implement a triple band selectable among 800˜1000 MHz band, 1500 MHz, and 1800˜2200 MHz band.

As aforementioned, the antenna according to the present invention can implement a dual band to be selectable in a necessary frequency band, and can implement a high function for increasing a bandwidth of a low frequency band.

Also, the antenna according to the present invention can be minimized.

Additionally, as the antenna according to the present invention can be applied to the mobile communication terminal as an internal type, the mobile communication terminal can be minimized and light.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An antenna of a mobile communication terminal comprising:
a first antenna portion having a plurality of strip portions curved with a certain interval, and having a feed point for an electric connection at one end thereof;
a second antenna portion having a plurality of strip portions curved with a certain interval, having an earth point for contacting a ground surface at one end thereof, and spaced from the first antenna portion with a certain interval; and
a connecting unit for connecting the first antenna portion and the second antenna portion.

2. The antenna of claim 1, wherein the first antenna portion comprises:
a first strip portion having a feed point for an electric connection at one end thereof;
a second strip portion curved from an end of the first strip portion with a certain angle and connected to the first strip portion;
a third strip portion curved from an end of the second strip portion with a certain angle and connected to the second strip portion; and
a fourth strip portion curved from an end of the third strip portion with a certain angle and connected to the third strip portion.

3. The antenna of claim 1, wherein the second antenna portion comprises:
a first strip portion having an earth point for an electric connection to a ground surface at one end thereof;
a second strip portion curved from an end of the first strip portion with a certain angle and connected to the first strip portion;
a third strip portion curved from an end of the second strip portion with a certain angle and connected to the second strip portion; and
a fourth strip portion curved from an end of the third strip portion with a certain angle and connected to the third strip portion.

4. The antenna of claim 2, wherein the fourth strip portion of the first antenna portion further comprises a plurality of strip portions curved from an end thereof with a certain angle and consecutively connected to form a strip pattern.

5. The antenna of claim 3, wherein the fourth strip portion of the second antenna portion further comprises a plurality of strip portions curved from an end thereof with a certain angle and consecutively connected to form a strip pattern.

6. The antenna of claim 1, wherein the respective strip portions of the first antenna portion and the second antenna portion are inwardly curved.

7. The antenna of claim 6, wherein the respective strip portion of the first antenna portion and the respective strip portion of the second antenna portion are inwardly curved in an opposite direction to each other.

8. The antenna of claim 6, wherein internal angles formed as the respective strip portions are inwardly curved have a range of 45° to 135°.

9. The antenna of claim 8, wherein the internal angles formed as the respective strip portions are inwardly curved are 90°.

10. The antenna of claim 1, wherein the respective strip portions of the first antenna portion and the respective strip portions of the second antenna portion are formed on the same plane.

11. The antenna of claim 1, wherein at least one of the strip portion of the first antenna portion and the strip portion of the second antenna portion is curved along a thickness direction in order to prevent a width increment at the time of a plane projection of the first antenna portion and the second antenna portion.

12. The antenna of claim 11, wherein the strip portion curved along the thickness direction is at least one of the fourth strip portion of the first antenna portion and the third/fourth strip portions of the second antenna portion.

13. The antenna of claim 1, further comprising an auxiliary antenna portion integrally connected to at least one of the first antenna portion and the second antenna portion for implementing a dual band with the first antenna portion and the second antenna portion.

14. The antenna of claim 13, wherein the auxiliary antenna portion comprises:
a first strip portion connected to one of the first antenna portion and the second antenna portion; and
a second strip portion curved from an end of the first strip portion with a certain angle and connected to the first strip portion.

15. The antenna of claim 14, further comprising a plurality of strip portions curved from an end of the second strip portion with a certain angle and consecutively connected to each other to form a strip pattern.

16. The antenna of claim 1, further comprising an antenna supporting unit for supporting the first antenna portion and the second antenna portion.

17. The antenna of claim 13, wherein the respective strip portions are inwardly curved.

18. The antenna of claim 13, wherein the respective strip portions are formed on the same plane as the first antenna portion and the second antenna portion.

19. The antenna of claim 13, further comprising an antenna supporting unit for supporting the first antenna portion, the second antenna portion, and the auxiliary antenna portion.

20. The antenna of claim 16, wherein the antenna supporting unit is provided with a ground portion arranged at a lower portion thereof and to which the earth point is electrically connected.

21. The antenna of claim 19, wherein the antenna supporting unit is provided with a ground portion arranged at a lower portion thereof and to which the earth point is electrically connected.

22. The antenna of claim 20, wherein the ground portion is a limited ground having a sectional shape corresponding to the first antenna portion and the second antenna portion at the time of a plane projection, and having a polygonal section that each edge has a length less than ¼ of a wavelength.

23. The antenna of claim 21, wherein the ground portion is a limited ground having a sectional shape corresponding to the first antenna portion and the second antenna portion at the time of a plane projection, and having a polygonal section that each edge has a length less than ¼ of a wavelength.

24. The antenna of claim 1, wherein the first antenna portion and the second antenna portion have a constant thickness along a width direction thereof.

25. The antenna of claim 1, wherein the first antenna portion and the second antenna portion have thickness varied according to steps along a width direction thereof.
